(19) United States
(12) Patent Application Publication
(10) Pub. No.: US 2006/0105226 A1
(43) Pub. Date: May 18, 2006

(54) Metal catalyst and fuel cell with electrode including the same

(75) Inventors: Ho-sung Kim, Suwon-si (KR); Suk-gi Hong, Suwon-si (KR); Duek-young Yoo, Seoul (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd

(21) Appl. No.: 11/272,829

(22) Filed: Nov. 15, 2005

(30) Foreign Application Priority Data
Nov. 16, 2004 (KR) 10-2004-0093574

(51) Int. Cl. H01M 4/86; H01M 4/02; B01J 31/00

(52) U.S. Cl. 429/40; 429/209; 502/150; 502/159

(57) ABSTRACT

A metal catalyst includes a conductive catalyst material and a proton conductive material coating formed on the surface of the conductive catalyst material. A fuel cell includes an electrode comprising the catalyst. The metal catalyst includes conductive catalyst particles uniformly coated with a proton conductive material to easily form and control a three-phase interface for an electrochemical reaction, facilitate the approach of gaseous reactants to a catalyst through a thin coating of a proton conductive material formed on catalyst particles, and effectively transfer protons produced by the electrochemical reaction. When an electrode is formed using the catalyst, a substantially ideal three-phase interfacial electrode structure may be formed, and a fuel cell including the electrode may have improved performance, such as high efficiency.

### BACKGROUND OF THE INVENTION

This application claims priority to and the benefit of Korean Patent Application No. 10-2004-0093574, filed on Nov. 16, 2004, in the Korean Intellectual Property Office, the disclosure of which is incorporated herein in its entirety by reference.

1. Field of the Invention

The present invention relates to a metal catalyst and a fuel cell that uses an electrode including the same. In particular, the present invention relates to a metal catalyst that has improved catalytic efficiency in an electrochemical reaction and has a structure that promotes the permeation of gaseous reactants, and a fuel cell having improved performance, such as higher efficiency, that uses an electrode including the metal catalyst.

2. Description of the Background

Fuel cells are emerging as a source of clean energy that can replace fossil fuels. The fuel cell is a power generating system that produces direct current by an electrochemical reaction between hydrogen and oxygen. A fuel cell may include a membrane electrode assembly (MEA) that has an electrolyte interposed between an anode and a cathode, and flow field plates for transferring gases.

The electrodes include catalyst layers that are formed on supporting layers made of carbon paper or carbon cloth. However, in the catalyst layer, it is difficult for gaseous reactants to reach the catalysts, and protons produced by the electrochemical reaction do not move rapidly. Thus, catalysts may not be used effectively in the electrodes.

The cathode and anode are prepared by casting a slurry including a catalyst and an ionomer on a gas diffusion layer, and drying the resulting layer to form a catalyst layer.

When the catalyst layer of an electrode is prepared in this way, the ionomer is doped in the catalyst or is simply mixed with the catalyst, which degrades the dispersion properties of the catalyst and causes significant agglomeration in the catalyst layer. As a result, an increase in unreacted catalysts due to secondary pores and non-uniform ionomers causes a reduction of catalyst utilization, a lack of fuel supply paths, and a reduction of the permeability of fuel, thereby significantly reducing the performance of the fuel cell. Additionally, it is difficult to form and control a three-phase interface for an electrochemical reaction, and the catalytic efficiency is reduced.

### SUMMARY OF THE INVENTION

The present invention provides a metal catalyst that exhibits an improved catalytic efficiency by having a substantially ideal three-phase interfacial structure that facilitates the approach of gaseous reactants to a catalyst and rapidly transfers protons produced by an electrochemical reaction. The present invention also provides a method for preparing the same, an electrode with improved efficiency that includes the metal catalyst, and a method for preparing the electrode. The present invention also provides a fuel cell with improved performance such as high efficiency by employing the electrode that includes the metal catalyst.

Additional features of the invention will be set forth in the description which follows, and in part will be apparent from the description, or may be learned by practice of the invention.

The present invention discloses a metal catalyst including a conductive catalyst material and a proton conductive material coating formed on the conductive catalyst material.

The present invention also discloses a method for preparing a metal catalyst including a conductive catalyst material and a proton conductive material coating formed on the surface of the conductive catalyst material. The method includes mixing an ionomer and a first solvent to obtain an ionomer solution, mixing the conductive catalyst material and the first solvent to obtain a conductive catalyst solution, dripping the conductive catalyst solution into the ionomer solution, dripping the resulting compound into a second solvent, and removing the first solvent and the second solvent from the resulting compound.

### BRIEF DESCRIPTION OF THE DRAWINGS

It is to be understood that both the foregoing general description and the following detailed description are exemplary and explanatory and are intended to provide further explanation of the invention as claimed.

FIG. 1A and FIG. 1B are schematic diagrams of the structure of a metal catalyst of the present invention and a conventional metal catalyst.

FIG. 2 illustrates the process of preparing an electrode according to the present invention.

FIG. 3 is a graph of the relationship between current and voltage (I—V) of an electrode prepared according to Example 1 of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

It will be understood that when an element such as a layer, film, region or substrate is referred to as being “on” another element, it can be directly on the other element or intervening elements may also be present. In contrast, when an element is referred to as being “directly on” another element, there are no intervening elements present.

The metal catalyst of the present invention includes conductive catalyst particles that are uniformly coated with a proton conductive material to easily form and control a three-phase interface for an electrochemical reaction, facilitate the approach of gaseous reactants to the catalyst through a thin coating of a proton conductive material formed on catalyst particles, and effectively transfer protons produced by the electrochemical reaction. When an electrode is formed using the catalyst, an ideal three-phase interfacial electrode structure may be formed and a fuel cell including the electrode may have improved performance, such as high efficiency.

A metal catalyst of the present invention includes a conductive catalyst material and a proton conductive material coating formed on the surface of the conductive catalyst material. The proton conductive material coating includes at least one ionomer including, but not limited to polybenzimidazole (PBI), polyetherketone (PEK), polyetherimide (PEI), polysulfone, perfluorosulfonic acid, and the above ionomers doped with an acid.

The acid may be, for example, phosphoric acid and have a concentration of about 85 wt % in water.

Examples of the conductive catalyst material may include, but are not limited to Pt, Fe, Co, Ni, Ru, Rh, Pd, Os, Ir, Cu, Ag, Au, Sn, Ti, Cr, mixtures thereof, alloys thereof, and a carbon material supporting these elements.

For example, the conductive catalyst material may be a carbon supported Pt (Pt/C) and the proton conductive material may be polybenzimidazole (PBI) doped with phosphoric acid. The doping level of phosphoric acid in PBI may be in the range of about 200 mol % to about 750 mol %.

In the metal catalyst of the present invention, the concentration of the proton conductive material may be about 1 wt % to about 50 wt % based on the total weight of the conductive catalyst material. When the concentration of the proton conductive material is less than about 1 wt %, the efficiency of the catalyst is reduced due to an inability to form a sufficient three-phase interface in the catalyst layer. When the concentration of the proton conductive material is more than about 50 wt %, the diffusion of gaseous reactants to the catalyst is slowed by the thick coating of the proton conductive material that may be formed on the catalyst, and thus is not preferable.

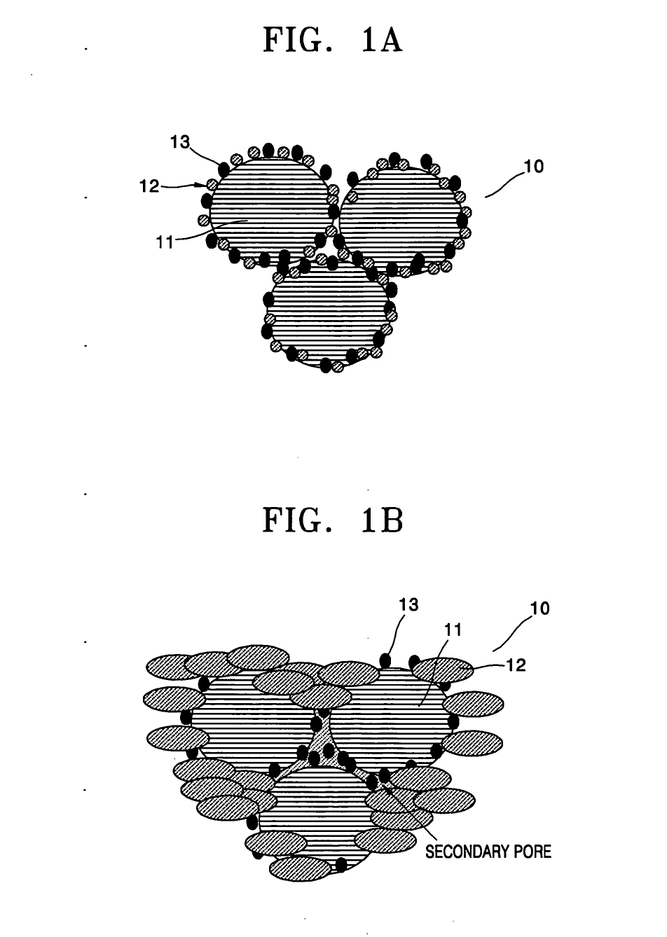

The structure of the metal catalyst of the present invention will be described with reference to FIG. 1A. As shown in FIG. 1A, a carbon supported Pt (Pt/C) catalyst may be used as a conductive catalyst, and polybenzimidazole (PBI) may be used as a proton conductive material.

In a metal catalyst 10, carbon 11 is coated with PBI 12 and Pt particles 13. Although it is not shown in FIG. 1A, Pt particles 13 may also be thinly coated with porous PBI.

Although it is not shown in FIG. 1A, when PBI is doped with an acid such as phosphoric acid, H₃PO₄ is bound to a N—H site of PBI through a hydrogen bond to form a proton transfer path. The carbon 11 acts as an electron transfer path and protons are transferred by the phosphoric acid.

FIG. 1B illustrates the structure of a conventional metal catalyst.

As shown in FIG. 1B, in a conventional metal catalyst 10, Pt particles 13 are present on carbon 11, and PBI 12 is located close to the carbon 11. In this structure, the dispersion properties of PBI and Pt/C deteriorate and it is difficult to obtain a three-phase interface for an electrochemical reaction. Thus, the catalytic efficiency is reduced.

In the present invention, PBI is coated on the Pt/C powder as a conductive catalyst through deposition of a polymer by phase separation. Amorphous PBI is completely dissolved in a first solvent such as N-methylpyrrolidone (NMP) to form a uniform solution. Simultaneously, Pt/C powder is mixed with the first solvent in a separate container. Then, Pt/C-NMP solution is added dropwise to the PBI-NMP solution, and the resulting solution is stirred in an ultrasonic stirrer.

The stirred mixture of the PBI-NMP solution and the Pt/C-NMP solution is dripped into a non-solvent second solution, such as water or hexane. Thus, phase separation between the first solvent and the non-solvent is induced, thereby causing PBI to be coated onto the Pt/C powder.

The thickness and degree of adsorption of the PBI film on the Pt/C powder may be adjusted based on the rotational speed (rpm) of the stirrer and the intensity of the ultrasonic waves. For example, the rotational speed of the stirrer may be about 250 rpm, the intensity of ultrasonic waves may be about 0.3 kW, and the stirring time may be about 20 minutes to about 30 minutes.

In the present invention, a conductive catalyst surrounded by an ionomer is formed, giving the catalyst the proton conductivity needed to easily form and control a three-phase interface for an electrochemical reaction. The catalyst also facilitates the approach of gaseous reactants to the catalyst through a thin coating formed on the catalyst and effectively transfers protons produced by an electrochemical reaction.

A method for preparing the metal catalyst and an electrode using the same will now be described in more detail.

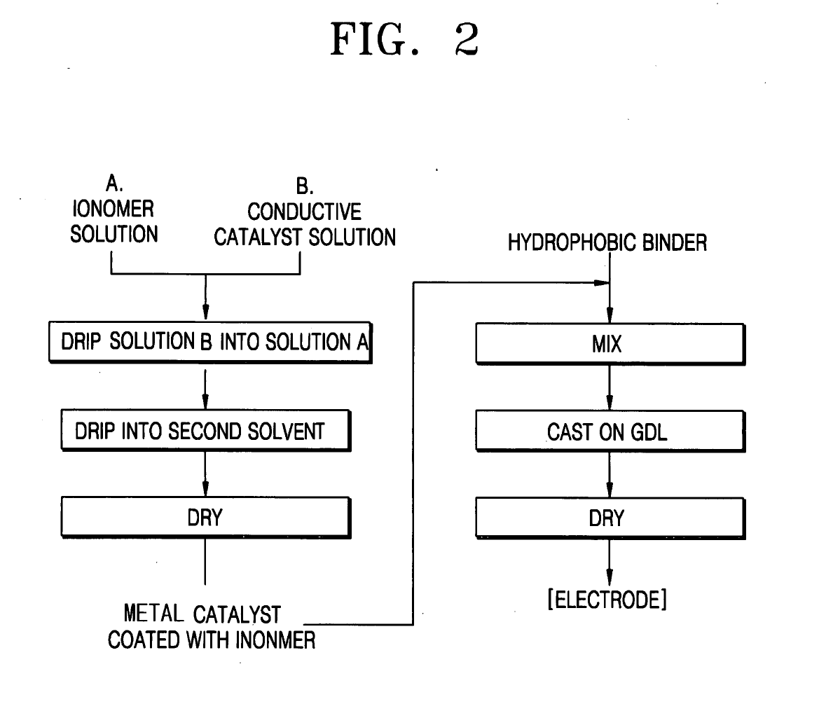

FIG. 2 illustrates the process of preparing the metal catalyst and an electrode that uses the metal catalyst according to the present invention. Referring to FIG. 2, a conductive catalyst material and a proton conductive ionomer are separately dispersed or dissolved in a first solvent to obtain conductive catalyst solution B and an ionomer solution A. Examples of the ionomer include PBI, PEK, PEI, polysulfone, perfluorosulfonic acid (such as Nafion®), etc. The concentration of the ionomer is about 1 wt % to about 50 wt % based on the total weight of the conductive catalyst material. When the concentration of the ionomer is less than about 1 wt %, the efficiency of the catalyst may be reduced due to an inability to form a sufficient three-phase interface in a catalyst layer. When the concentration of the ionomer is greater than about 50 wt %, the diffusion of gaseous reactants to the catalyst may be slowed by the thick layer of ionomer formed on the catalyst.

The first solvent dissolves the proton conductive material and disperses the conductive catalyst material. Examples of the first solvent may include, but are not limited to N-methylpyrrolidone (NMP), dimethylacetamide (DMAc), dimethylformamide (DMF), trifluoroacetic acid (TFA), etc. The concentration of the first solvent for dispersing the conductive catalyst material is about 400 wt % to about 600 wt % based on the total weight of the conductive catalyst material. The concentration of the first solvent for dissolving the ionomer is about 4000 wt % to about 6000 wt % based on the total weight of the ionomer. When the concentration of the first solvent is less than the above range, the proton conductive material is not sufficiently dissolved and the conductive catalyst material is not uniformly dispersed. When the concentration of the first solvent is greater than the above range, the mixture takes a long time to dry.

After the conductive catalyst solution B is dripped into the ionomer solution A, the mixture is dripped into a second solvent. Through this dripping process, an ionomer film is chemically adsorbed onto the conductive catalyst by phase separation, and the bonding between the conductive catalyst and the ionomer is maintained.

The second solvent has a low boiling point, and thus is easily evaporated and removed. Such a solvent is described as a “non-solvent.” Examples of the second solvent may include, but are not limited to water and hexane. The concentration of the second solvent is about 20000 wt % to about 30000 wt % based on the total weight of the ionomer.

After the above process, the resulting solution is dried and then the resulting dried composition may be treated with an acid. The acid may be a phosphoric acid or a phosphoric acid solution such as an 85 wt % aqueous solution of phosphoric acid solution.

Through the above process, a metal catalyst including the conductive catalyst coated with the proton conductive material is formed. A porous coating is discontinuously or continuously formed on the Pt/C catalyst by phase separation, depending on the PBI concentration. That is, as the PBI concentration increases, a continuous coating is formed, but when the PBI concentration is less than or equal to about 20 wt %, and for example about 15 wt % to about 20 wt %, based on the total weight of Pt/C, a porous discontinuous layer is formed.

The obtained metal catalyst may be mixed with a hydrophobic binder and a third solvent and cast on a gas diffusion layer (GDL). The mixture is dried to obtain an electrode. Carbon paper or carbon cloth may be used as the GDL.

Examples of the hydrophobic binder may include, but are not limited to polytetrafluoroethylene (PTFE) and fluorinated ethylene propylene (FEP). The concentration of the hydrophobic binder may be about 1 wt % to about 40 wt % based on the total weight of the metal catalyst. When the concentration of the hydrophobic binder is out of the above range, satisfactory proton conductivity and electrical conductivity may not be obtained.

The third solvent and the concentration thereof are selected based on the hydrophobic binder. Examples of the third solvent may include water, isopropyl alcohol, and a mixture thereof, for example. The concentration of the third solvent is about 500 wt % to about 10,000 wt % based on the total weight of the metal catalyst.

The conditions for the drying process are not limited, but general drying at about 60° C. to 120° C. or freeze drying at about −20° C. to about −60° C. may be performed. When the general drying temperature is out of the above range, the drying is inadequate and the carbon support is oxidized. When the freeze drying temperature is out of the above range, agglomeration occurs.

Then, if necessary, the obtained electrode may be doped with an acid. When metal catalyst particles coated with PBI are doped with phosphoric acid, for example, H₃PO₄ is bound to an N—H site of PBI through a hydrogen bond to form a proton transfer path.

A fuel cell of the present invention will now be described in detail.

The fuel cell of the present invention includes a cathode, an anode, and an electrolyte membrane interposed between the cathode and the anode. At least one of the cathode and the anode includes the metal catalyst of the present invention, as described above.

The fuel cell of the present invention may be embodied as a phosphoric acid fuel cell (PAFC), a proton exchange membrane fuel cell (PEMFC), or a direct methanol fuel cell (DMFC), for example. The structure and preparation of these fuel cells are not limited, and since they are specifically described in a variety of literature, they will not be described here.

The present invention will be described in greater detail with reference to the following examples. The following examples are for illustrative purposes only and are not intended to limit the scope of the invention.

### EXAMPLE 1

0.2 g of PBI and 10 mL of NMP were stirred at 250 rpm at room temperature for 30 minutes to obtain a PBI solution.

Separately, 2.0 g of Pt/C and 10 mL of NMP were stirred at 250 rpm at room temperature for 10 minutes to obtain a Pt/C solution.

The Pt/C solution was dripped into the PBI solution under ultrasonic conditions, and then the resulting mixture was dripped into 50 mL of water. Next, the solution was dried at 80° C. for 24 hours to obtain a Pt/C catalyst coated with PBI.

1 g of the Pt/C catalyst coated with PBI was mixed with 0.1 g of Fluorosarf® and 9.9 mL of hydrofluoropolyether (HFPE) as a solvent and was stirred at room temperature for about 3 hours to obtain a catalyst layer forming composition in a slurry form.

The slurry was coated onto carbon paper using an applicator with a gap of about 120 μm, and then dried at 80° C. for 3 hours and 120° C. for 1 hour to obtain an electrode.

### EXAMPLE 2

An electrode was prepared in the same manner as in Example 1, except that hexane was used instead of water to prepare the Pt/C catalyst coated with PBI.

### EXAMPLE 3

An electrode was prepared in the same manner as in Example 1, except that the slurry was freeze dried to obtain the electrode.

### EXAMPLE 4

An electrode was prepared in the same manner as in Example 1, except that the prepared Pt/C catalyst coated with PBI was treated with phosphoric acid.

### EXAMPLE 5

The electrode obtained by Example 1 was treated with phosphoric acid, and then a fuel cell was prepared.

### EXAMPLE 6

A fuel cell was prepared using a cathode including the catalyst of Example 1, an anode including a PtRu black catalyst and a Nafion 117® electrolyte membrane. Hydrogen and air were used as a fuel and an oxidant, respectively.

### COMPARATIVE EXAMPLE 1

1 g of Pt/C catalyst, 0.1 g of PBI and polyvinylidene fluoride (PVDF) as a hydrophobic binder were mixed and stirred at room temperature for about 3 hours to obtain a catalyst layer forming composition in a slurry form.

The slurry was coated onto carbon paper using an applicator with a gap of about 120 μm, and then dried at 80° C. for 3 hours and 120° C. for 1 hour to obtain an electrode.

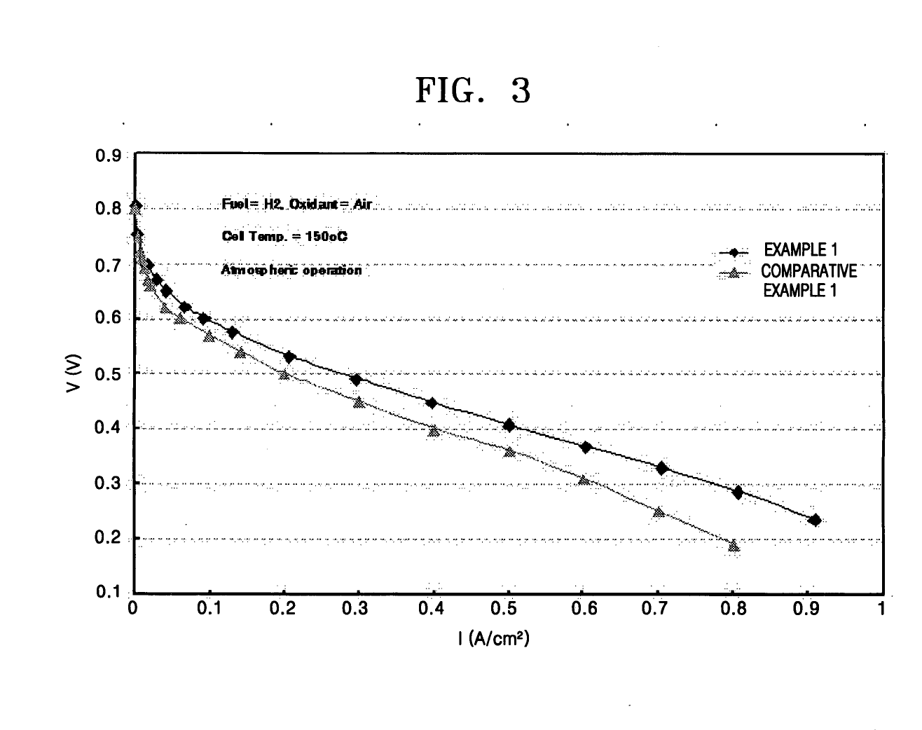

The current-voltage characteristics (I—V) of the electrodes prepared according to Example 1 and Comparative Example 1 were examined, and the results are illustrated in FIG. 3.

FIG. 3 shows the polarization properties of the unit cells that include the electrode comprising the catalyst powder coated with PBI according to the present invention and the electrode prepared in a conventional manner. Pure hydrogen was supplied to the anode at a rate of about 100 mL/min and air was supplied to the cathode at a rate of about 200 mL/min. The unit cells were operated at 150° C. The electrode of Example 1 had a voltage of about 0.53 V at a current density of 0.2 A/cm², whereas the electrode of Comparative Example 1 had a lower voltage of about 0.5 V.

To quantitatively identify the coating level of the Pt/C powder coated with PBI of Example 1 and Comparative Example 1, TEM-EDS analysis was carried out.

As a result, the concentration of N of PBI on the Pt/C powder of the electrode of Comparative Example 1 was about 40 wt %, whereas the concentration of N in the Pt/C powder coated with PBI of Example 1 was about 20 wt %. Thus, it can be seen that the Pt/C in Example 1 was more uniformly coated with PBI than in Comparative Example 1.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A metal catalyst, comprising:
a conductive catalyst material; and
a proton conductive material coating formed on the surface of the conductive catalyst material.

2. The metal catalyst of claim 1,
wherein the proton conductive material is at least one ionomer selected from the group consisting of polybenzimidazole, polyetherketone (PEK), polyetherimide (PEI), polysulfone, perfluorosulfonic acid, and the above ionomers doped with an acid.

3. The metal catalyst of claim 2,
wherein the acid is phosphoric acid.

4. The metal catalyst of claim 1,
wherein the conductive catalyst material is selected from the group consisting of Pt, Fe, Co, Ni, Ru, Rh, Pd, Os, Ir, Cu, Ag, Au, Sn, Ti, Cr, a mixture thereof, an alloy thereof, or a carbon material having these elements supported thereon.

5. The metal catalyst of claim 1,
wherein the conductive catalyst material is carbon supported Pt (Pt/C), and
wherein the proton conductive material is polybenzimidazole doped with phosphoric acid.

6. The metal catalyst of claim 1,
wherein the concentration of the proton conductive material is about 1 wt % to about 50 wt % based on the total weight of the conductive catalyst material.

7. A method for preparing a metal catalyst including a conductive catalyst material and a proton conductive material coating formed on the surface of the conductive catalyst material, comprising:
mixing an ionomer and a first solvent to obtain an ionomer solution;
mixing the conductive catalyst material and the first solvent to obtain a conductive catalyst solution;
dripping the conductive catalyst solution into the ionomer solution to form a mixture;
dripping the mixture into a second solvent; and
removing the first solvent and the second solvent from the mixture to form a metal catalyst.

8. The method of claim 7, further comprising:
treating the metal catalyst with an acid.

9. The method of claim 8,
wherein the acid is a phosphoric acid or a phosphoric acid solution.

10. The method of claim 7,
wherein the first solvent is at least one selected from the group consisting of N-methylpyrrolidone (NMP), dimethylacetamide (DMAc), dimethylformamide (DMF), and trifluoroacetic acid (TFA).

11. The method of claim 7,
wherein the second solvent is at least one selected from the group consisting of water and hexane.

12. The method of claim 7,
wherein the ionomer is at least one selected from the group consisting of polybenzimidazole, polyetherketone (PEK), polyetherimide (PEI), polysulfone and perfluorosulfonic acid.

13. The method of claim 7,
wherein the concentration of the ionomer is about 1 wt % to about 50 wt % based on the total weight of the conductive catalyst material.

14. The method of claim 7,
wherein the concentration of the first solvent is about 4000 wt % to about 6000 wt % based on the total weight of the ionomer, and
wherein the concentration of the first solvent solution is about 400 wt % to about 600 wt % based on the total weight of the conductive catalyst material.

15. The method of claim 7,
wherein the concentration of the second solvent is about 20,000 wt % to about 40,000 wt % based on the total weight of the ionomer.

16. An electrode, comprising:
the metal catalyst of claim 1.

17. A method for preparing an electrode, comprising:
mixing the metal catalyst of claim 1 with a hydrophobic binder and a third solvent to obtain a catalyst layer forming composition;
coating the catalyst layer forming composition onto an electrode support and drying the catalyst layer forming composition; and
treating the dried catalyst layer forming composition with an acid.

18. The method of claim 17,
wherein the hydrophobic binder is polytetrafluoroethylene (PTFE) and fluorinated ethylene propylene (FEP).

19. The method of claim 18,
wherein the concentration of the hydrophobic binder is about 1 wt % to about 40 wt % based on the total weight of the metal catalyst.

20. The method of claim 17,
wherein the third solvent is selected from the group consisting of water and isopropyl alcohol.

21. The method of claim 17,
wherein the acid is a phosphoric acid or a phosphoric acid solution.

22. The method of claim 17,
wherein the drying is carried out at about 60° C. to about 120° C. or is carried out by freeze drying at about −20° C. to about −60° C.

23. A fuel cell, comprising:
a cathode;
an anode; and
an electrolyte membrane interposed between the cathode and the anode,
wherein at least one of the cathode and the anode comprise the metal catalyst of claim 1.
